(19) United States
(12) Patent Application Publication
(10) Pub. No.: US 2024/0039614 A1
(43) Pub. Date: Feb. 1, 2024

(54) CONFIGURING A REPEATER SYSTEM ACCORDING TO CONFIGURATION OF BASE STATION

(71) Applicant: CommScope Technologies LLC, Hickory, NC (US)

(72) Inventors: Suresh N. Sriram, Bangalore (IN); Sudarshana Varadappa, Bangalore (IN)

(73) Assignee: CommScope Technologies LLC, Hickory, NC (US)

(21) Appl. No.: 18/358,781

(22) Filed: Jul. 25, 2023

Related U.S. Application Data
(60) Provisional application No. 63/393,069, filed on Jul. 28, 2022.

(51) Int. Cl. H04B 7/155; H04W 72/1273; H04W 76/27

(52) U.S. Cl. CPC H04B 7/155; H04W 72/1273; H04W 76/27

(57) ABSTRACT

The present disclosure describes various techniques of automatically configuring a repeater system. In one embodiment, the techniques of present disclosure configure the repeater system as a dummy user equipment and connect to a cell served by a base station coupled to the repeater system and establish two-way communication between the repeater system and the base station for determining one or more signaling parameters related to the configuration of the base station. In another non-limiting embodiment, the techniques of the present disclosure operate the repeater system in a listener only mode and perform various signal processing/calculations to determine the one or more signaling parameters related to the configuration of the base station. Once the one or more signaling parameters are determined, the techniques of the present disclosure may configure the repeater system based at least in part on the one or more signaling parameters.

### CROSS REFERENCE TO RELATED APPLICATION

This application claims the benefit of U.S. Provisional Patent Application Ser. No. 63/393,069, filed on Jul. 28, 2022, which is hereby incorporated herein by reference in their entirety.

### TECHNICAL FIELD

The present disclosure in general relates to repeater systems. More particularly, but not exclusively, the present disclosure relates to methods and systems for automatically configuring a repeater system according to configuration of base station(s).

### BACKGROUND

A repeater system (such as a distributed antenna system or a single-node repeater) is typically used to enhance wireless radio frequency (RF) coverage provided by one or more base stations. Broadly, the repeater system enhances the wireless RF coverage by receiving one or more RF signals output from the one or more base stations, amplifying the received one or more RF signals, and transmitting the amplified signals to user equipment (UEs) in downlink direction. In the uplink direction, the repeater system receives one or more RF signals output by the UEs, amplifies the received one or more RF signals, and transmits the amplified signals to the one or more base stations.

Generally, the repeater system may be used to enhance indoor or outdoor wireless coverages of the one or more base stations, for example, in stadiums, buildings (office buildings, hospitals, hotels, malls, trade centers, etc.), metro stations, airports, trains, tunnels, canyons, but not limited thereto. To enhance the wireless coverage, each of the one or more base stations may be coupled to the repeater system via one or more cables or via wireless connections (e.g., using one or more donor antennas).

Existing repeater systems are typically designed for use with existing wireless air interface standards (such as GSM, UMTS, and LTE) and may not be suitable for use with newer wireless air interface standards (such as the Fifth Generation (5G) New Radio (NR) standards). Thus, there exists a need for further improvements in the existing technology, especially there exists a need to develop techniques that can configure the repeater system for use with the newer wireless air interface standards (e.g., 5G NR).

The information disclosed in this background section is only for enhancement of understanding of the general background of the disclosure and should not be taken as an acknowledgement or any form of suggestion that this information forms the prior art already known to a person skilled in the art.

### SUMMARY

According to an aspect of the present disclosure, methods, systems, and computer readable media are provided for configuring a repeater system according to configurations of base station(s) coupled with the repeater system.

One non-limiting embodiment of the present disclosure is directed to a method of configuring a repeater system. The method comprises receiving a first downlink signal from at least one base station (BS) serving a cell and determining a first set of parameters related to configuration of the at least one BS based at least in part on the first downlink signal. The method further comprises configuring the repeater system as a dummy user equipment (UE) for connecting to the cell, establishing two-way communication between the repeater system and the at least one BS, and exchanging information between the repeater system and the at least one BS as a part of connecting to the cell and establishing the two-way communication between the repeater system and the at least one BS. Exchanging the information between the repeater system and the at least one BS comprises receiving a second downlink signal from the at least one BS. The method further comprises determining a second set of parameters related to the configuration of the at least one BS based on the first set of parameters and the second downlink signal and configuring the repeater system based at least in part on the first and the second sets of parameters for serving one or more UEs of the cell.

Another non-limiting embodiment of the present disclosure is directed to a method of configuring a repeater system. The method comprises receiving a first downlink signal from at least one base station (BS) serving a cell and determining a first set of parameters related to configuration of the at least one BS based at least in part on the first downlink signal. The method further comprises determining a cell identity corresponding to the cell served by the at least one BS and determining a second set of parameters related to the configuration of the at least one BS while operating the repeater system in a listener only mode. The method further comprises determining a first subset of parameters of the second set of parameters by correlating at least one reference signal generated using the determined cell identity with one or more reference signals transmitted by the at least one BS. The method further comprises determining a second subset of parameters of the second set of parameters based at least on the first subset of parameters and the first set of parameters and determining a third subset of parameters of the second set of parameters based at least on the first and second subsets of parameters and uplink and downlink signals received by the repeater system. The method further comprises configuring the repeater system based at least in part on the first and the second sets of parameters for serving one or more UEs of the cell.

Another non-limiting embodiment of the present disclosure is directed to a repeater system comprising a processing circuitry configured to receive a first downlink signal from at least one base station (BS) serving a cell and determine a first set of parameters related to configuration of the at least one BS based at least in part on the first downlink signal. The processing circuitry is further configured to configure the repeater system as a dummy user equipment (UE) for connecting to the cell, establishing two-way communication between the repeater system and the at least one BS, and exchanging information between the repeater system and the at least one BS as a part of connecting to the cell and establishing the two-way communication between the repeater system and the at least one BS, where exchanging the information between the repeater system and the at least one BS comprises receiving a second downlink signal from the at least one BS. The processing circuitry is further configured to determine a second set of parameters related to the configuration of the at least one BS based on the first set of parameters and the second downlink signal. The processing circuitry is further configured to configure the repeater system based at least in part on the first and the second sets of parameters for serving one or more UEs of the cell

Another non-limiting embodiment of the present disclosure is directed to a repeater system comprising a processing circuitry configured to receive a first downlink signal from at least one base station (BS) serving a cell and determine a first set of parameters related to configuration of the at least one BS based at least in part on the first downlink signal. The processing circuitry is further configured to determine a cell identity corresponding to the cell served by the at least one BS and determine a second set of parameters related to the configuration of the at least one BS while operating the repeater system in a listener only mode, where to determine the second set of parameters, the processing circuitry is configured to determine a first subset of parameters of the second set of parameters by correlating at least one reference signal generated using the determined cell identity with one or more reference signals transmitted by the at least one BS; determine a second subset of parameters of the second set of parameters based at least on the first subset of parameters and the first set of parameters; and determine a third subset of parameters of the second set of parameters based at least on the first and second subsets of parameters and uplink and downlink signals received by the repeater system. The processing circuitry is further configured to configure the repeater system based at least in part on the first and the second sets of parameters for serving one or more UEs of the cell.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Further aspects and advantages of the present disclosure will be readily understood from the following detailed description with reference to the accompanying drawings. Reference numerals have been used to refer to identical or functionally similar elements. The figures together with a detailed description below, are incorporated in and form part of the specification, and serve to further illustrate the embodiments and explain various principles and advantages, in accordance with the present disclosure wherein:

FIG. 1 shows a block diagram of a communication system 100 comprising a single node repeater 102 in which the techniques of the present disclosure may be implemented, in accordance with some embodiments of the present disclosure.

FIG. 2 shows another block diagram of a communication system 200 comprising a distributed antenna system (DAS) 202 in which the techniques of the present disclosure may be implemented, in accordance with some embodiments of the present disclosure.

FIG. 3 shows an exemplary list 300 of a plurality of signaling parameters related to configuration of a base station, in accordance with some embodiments of the present disclosure.

FIG. 4 shows a high level call flow diagram 400 illustrating message exchanges in 5G standalone initial attach process, in accordance with some embodiments of the present disclosure.

FIG. 5 shows an exemplary resource grid 500 illustrating SSB positioning, in accordance with some embodiments of the present disclosure.

FIG. 6 shows a high-level block diagram of an apparatus 600, in accordance with some embodiments of the present disclosure.

FIG. 7 shows a flowchart of an exemplary method 700 for configuring a repeater system, in accordance with some embodiments of the present disclosure.

FIG. 8 shows a flowchart of an exemplary method 800 for configuring a repeater system, in accordance with some embodiments of the present disclosure.

It should be appreciated by those skilled in the art that any block diagrams herein represent conceptual views of the illustrative systems embodying the principles of the present disclosure. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present disclosure described herein as “exemplary” is not necessarily to be construed as preferred or advantageous over other embodiments.

While the disclosure is susceptible to various modifications and alternative forms, specific embodiments thereof have been shown by way of examples in the drawings and will be described in detail below. It should be understood, however, that it is not intended to limit the disclosure to the particular form disclosed, but on the contrary, the disclosure is to cover all modifications, equivalents, and alternatives falling within the spirit and the scope of the disclosure.

The terms “comprise(s)”, “comprising”, “include(s)”, or any other variations thereof, are intended to cover a non-exclusive inclusion, such that a setup, device, apparatus, system, or method that comprises a list of components or steps does not include only those components or steps but may include other components or steps not expressly listed or inherent to such setup or device or apparatus or system or method. In other words, one or more elements in a device or system or apparatus preceded by “comprises . . . a” does not, without more constraints, preclude the existence of other elements or additional elements in the system.

The terms like “physical layer cell identity” and “cell identity” may be used interchangeably throughout the description.

In the following detailed description of the embodiments of the disclosure, reference is made to the accompanying drawings that form a part hereof, and in which are shown by way of illustration of specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense. In the following description, well known functions or constructions are not described in detail since they would obscure the description with unnecessary detail.

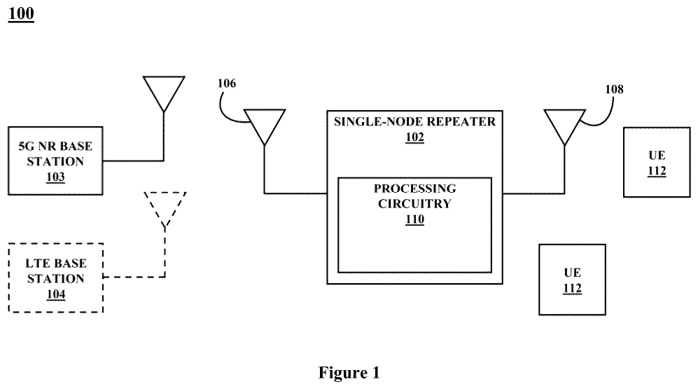

Referring now to FIG. 1 which shows a block diagram illustrating an exemplary communication system 100 comprising a repeater system 102, in which the techniques of the present disclosure may be implemented. The repeater system 102 may also be referred to as “a single-node repeater” 102 which may be configured to be used with at least one base station (BS). The at least one base station may comprise at least one Fifth Generation (5G) New Radio (NR) base station 103 and/or at least one fourth generation (4G) Long Term Evolution (LTE) base station 104.

The 5G NR base station 103 may implement a 5G NR wireless interface and may serve one or more user equipment (UEs) 112 (e.g., 5G NR capable UEs) of a 5G NR cell using 5G NR time-division duplexing (TDD) and/or 5G NR frequency-division duplexing (FDD). The 5G NR base station 103 may also be referred to as a “Next Generation NodeB”, “gNodeB”, or simply “gNB”. The LTE base station 104 may also be referred to as an “evolved NodeB”, “eNodeB”, or simply “eNB”. In one non-limiting embodiment, the repeater system 102 may be communicatively coupled with the at least one base station via a wireless connection e.g., using a donor antenna 106.

The repeater system 102 may comprise a processing circuitry 110 which may be configured to operate the repeater system 102 in an uplink mode and a downlink mode. When operating in the downlink mode, the processing circuitry 110 may be configured to receive downlink signals output by the at least one base station for wireless transmission to the UEs 112, generate amplified versions of the downlink signals, and transmit the amplified version of the downlink signals into a coverage area associated with the repeater system 102 via one or more coverage antennas 108 associated with the repeater system 102. When operating in the uplink mode, the processing circuitry 110 may be configured to receive, via the coverage antennas 108, uplink signals transmitted by the UEs 112, generate amplified versions of uplink signals, and transmit the amplified versions of the uplink signals to the at least one base station. The processing circuitry 110 may be configured to repeat downlink and uplink signals using TDD and/or FDD. For instance, to repeat downlink and uplink signals using TDD, the processing circuitry 110 may be configured to switch between operating in the downlink mode and the uplink mode. Likewise, to repeat downlink and uplink signals using FDD, the processing circuitry 110 may be configured to operate in the downlink direction and the uplink direction simultaneously, with the downlink and uplink directions using different frequencies. Thus, references to “when operating in the downlink mode” or “when operating in the uplink mode” should not be construed as necessarily limiting the present disclosure only to TDD implementations and should be construed as also describing FDD implementations in which references to “when operating in the downlink mode,” “when operating in the uplink mode,” and “switching” between operating in downlink mode and uplink mode can also be construed as, in the context of FDD implementations, to be referring to “for operation in the downlink direction,” “for operation in the uplink direction,” and without necessarily “switching” between operating in the downlink direction and uplink direction and, instead, having downlink and uplink operations occur simultaneously for the respective frequencies.

The processing circuitry 110 may also be configured to align configuration/settings of the repeater system 102 in accordance with configuration/settings of the at least one base station using the techniques discussed in the present disclosure, and accordingly operate the repeater system 102 in uplink and downlink modes by repeating uplink and downlink signals using TDD and/or FDD. To do this, in one non-limiting embodiment, the processing circuitry 110 may be adapted to configure the repeater system 102 as a dummy UE for connecting to a cell served by the at least one base station, establishing two-way communication with the at least one base station, and acquiring one or more signaling parameters related to the configuration/settings of the at least one base station. In another non-limiting embodiment, the processing circuitry 110 may be adapted to operate the repeater system 102 in a listener only mode and perform various signal processing and calculations to acquire the one or more signaling parameters related to the configuration/settings of the at least one base station. In one non-limiting embodiment, some or all functionalities of the processing circuitry 110 may be implemented using a measurement receiver (not shown).

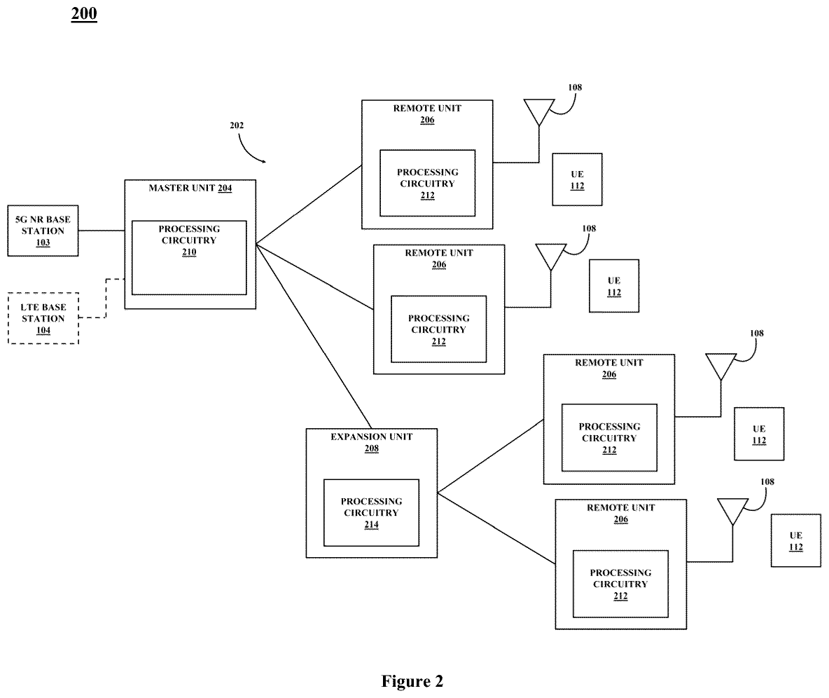

Referring now to FIG. 2 which shows a block diagram illustrating an exemplary communication system 200 comprising a repeater system 202, in which the techniques of the present disclosure may be implemented. The repeater system 202 may be “a distributed antenna system (DAS)” 102 which may be configured to be used with the at least one base station (BS). The at least one base station may comprise the at least one gNB 103 and/or the at least eNB 104.

The DAS 202 may typically include at least one master unit 204 (also referred as “Central Access Node (CAN)”) which may be communicatively coupled to a plurality of remotely located access points or antenna units 206 (also referred as “remote units (RU)”). Each remote unit 206 may be coupled either directly to the master unit 204 or via at least one intermediary or expansion unit 208 (also referred as “Transport Expansion Node (TEN)”). The at least one expansion unit 208 may extend the coverage range of the DAS 202.

The DAS 202 may be positioned in an area having low signal coverage (e.g., inside a building) to improve the coverage provided by the at least one base station which is communicatively coupled to the master unit 204 of the DAS 202. Typically, the at least one base station may be coupled to the master unit 204 via a wired connection (e.g., via one or more cables). In one non-limiting embodiment, the gNB 103 may be coupled to the master unit 204 via a wireless connection e.g., using donor antennas.

The processing circuitry 210 (or the master unit 204 more generally) may be configured to align the configuration/settings of the DAS 202 in accordance with configuration/settings of the at least one base station and accordingly operate the DAS 202 in the uplink mode and the downlink mode by repeating uplink and downlink signals using TDD and/or FDD. When operating in the downlink mode, the master unit 204 may receive downlink signals from the at least one base station via the wired or wireless connection and may generate one or more digital signals or downlink transport signals from the downlink base station signals. The master unit 204 may transmit the generated downlink transport signals to the remote units 206 over a communication medium including, but not limited to, coaxial cable, optical fiber, or any other suitable wireless medium. In one non-limiting embodiment, the master unit 204 may provide the downlink transport signals to the remote units 206 via one or more expansion units 208. The remote units 206 may receive the downlink transport signal(s) from the master unit 204 and may use the received downlink transport signals to generate one or more downlink radio frequency (RF) signals. The remote units 206 may amplify the downlink RF signals and radiate the amplified downlink RF signals from coverage antennas 108 associated with the remote units 206. The downlink RF signals may be radiated for reception by the UEs 112.

Likewise, when operating in the uplink mode, the remote units 206 may receive one or more uplink RF signals from the UEs 112 and may generate one or more uplink digital signals or uplink transport signals from the uplink RF signals. The remote units 206 may transmit the generated uplink transport signals towards the master unit 204 either directly or via the expansion unit(s) 208. The master unit 204 may receive the uplink transport signals transmitted by the remote units 206 and may use the received uplink transport signals to generate one or more uplink base station signals to be transmitted to the at least one base station.

Although each remote unit 206 is shown in FIG. 2 as having only a single coverage antenna 108 for ease of illustration, it is to be understood each remote unit 206 may have multiple coverage antennas 108 coupled thereto.

The DAS 202 may use either digital transport, or analog transport, or a combination of digital and analog transport for generating and communicating the transport signals between the master unit 204, the remote units 206, and the expansion units 208. The master unit 204 (and the DAS 202 more generally) may be configured to repeat the downlink and uplink signals using TDD and/or FDD. For instance, to repeat downlink and uplink signals using TDD, the master unit 204 (and the DAS 202 more generally) may be configured to switch between operating in the downlink mode and the uplink mode. Likewise, to repeat downlink and uplink signals using FDD, the master unit 204 (and the DAS 202 more generally) may be configured to operate in the downlink direction and the uplink direction simultaneously, with the downlink and uplink directions using different frequencies. Thus, references to “when operating in the downlink mode” or “when operating in the uplink mode” should not be construed as necessarily limiting the present disclosure only to TDD implementations and should be construed as also describing FDD implementations in which references to “when operating in the downlink mode,” “when operating in the uplink mode,” and “switching” between operating in downlink mode and uplink mode can also be construed as, in the context of FDD implementations, to be referring to “for operation in the downlink direction,” “for operation in the uplink direction,” and without necessarily “switching” between operating in the downlink direction and uplink direction and, instead, having downlink and uplink operations occur simultaneously for the respective frequencies.

For the sake of simplicity and for illustrative purposes, it has been shown in FIG. 2 that the DAS 202 comprises a single master unit 204, a single expansion unit 208, and four remote units 206. However, the present disclosure is not limited thereto and, in general, the DAS 202 may include any number of master units 204, any number of remote units 206 for communicating signals between any number of base stations and any number of user equipment (UEs) 112. The DAS 202 may include any number of expansion units 208 which may communicate signals between the master units 204 and the remote units 206. The DAS 202 may also include other devices in addition to the master units 204, the remote units 206, and the expansion units 208. For example, in some aspects, the DAS 202 may include a base station router or other interface device for receiving signals from the base stations and providing the received signals to the master unit 204.

Each of the master unit 204, expansion unit 208, and remote unit 206 may include processing circuitry 210, 212, and 214 respectively. The processing circuitry 210 may be configured to implement various operations of the master unit 204, the processing circuitry 212 may be configured to implement various operations of the remote unit 206, and the processing circuitry 214 may be configured to implement various operations of the expansion unit 208. In one non-limiting embodiment, some of all functionalities of the processing circuitry 210 may be implemented using a measurement receiver (not shown).

The processing circuitry 210, 212, and 214 (and the various features thereof) can be implemented in analog circuitry, digital circuitry, or combinations of analog circuitry and digital circuitry. The processing circuitry 210, 212, and 214 may comprise one or more appropriate connectors, attenuators, combiners, splitters, amplifiers, filters, duplexers, analog-to-digital converters, digital-to-analog converters, electrical-to-optical converters, optical-to-electrical converters, mixers, field-programmable gate arrays (FPGAs), microprocessors, processors, transceivers, framers, etc., to implement the various features described here.

Each of the various nodes of the DAS 202 (for example, the master units 204, expansion units 208, and remote units 206) may be implemented as one or more physical network functions (PNFs) (for example, using dedicated physical programmable devices and other circuitry) and/or one or more virtual network functions (VNFs) (for example, using one or more general purpose servers (possibly with hardware acceleration) in a scalable cloud environment and in different locations within an operator's network (for example, in the operator's “edge cloud” or “central cloud”). References to “processing circuitry” should be construed as covering, and referring to, implementations using PNFs, VNFs, and combinations thereof.

For example, one or more nodes or functions of a traditional DAS (such as a master unit 204 and a expansion unit 208) may be implemented using one or more VNFs executing on one or more physical server computers (also referred to here as “physical servers” or just “servers”) (for example, one or more commercial-off-the-shelf (COTS) servers of the type that are deployed in data centers or “clouds” maintained by enterprises, communication service providers, or cloud services providers). In such a “virtualized” DAS example, the remote units 206 can be implemented as a PNF and is deployed in or near a physical location where radio coverage is to be provided. In such a virtualized DAS example, at least some of the nodes of the virtualized DAS can be interconnected with each other using a switched Ethernet network.

The processing circuitry 210 (and the master unit 204 more generally) may be configured to align the configuration/settings of the DAS 202 in accordance with the configuration/settings of the at least one base station using the techniques discussed in the present disclosure. To do this, in one non-limiting embodiment, the processing circuitry 210 may be adapted to configure the master unit 204 (or the DAS 202 more generally) as a dummy UE for connecting to a cell served by the at least one base station and establishing two-way communication between the master unit 204 and the at least one base station in order to acquire one or more signaling parameters related to the configuration/settings of the at least one base station. In another non-limiting embodiment, the processing circuitry 210 may be adapted to operate the master unit 204 in a listener only mode and perform various signal processing/calculations to acquire the one or more signaling parameters related to the configuration/settings of the at least one base station.

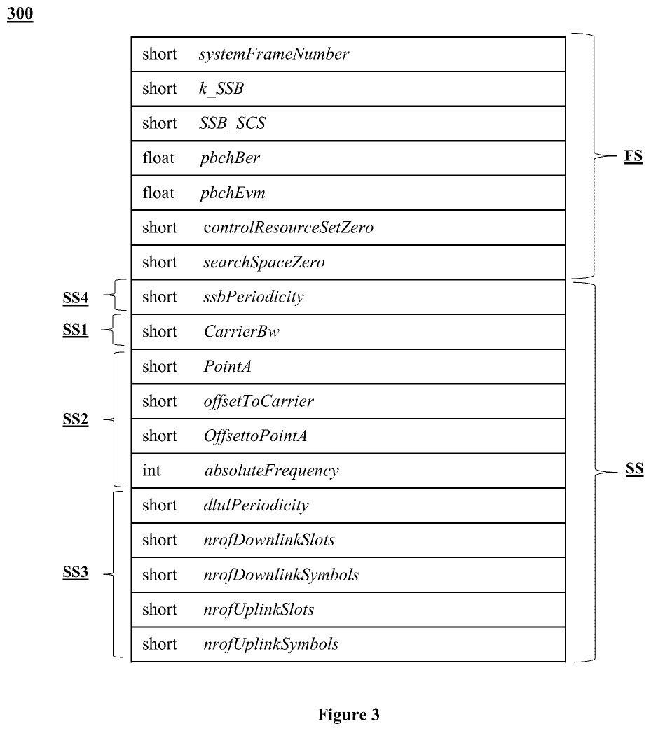

Typically, the repeater system (i.e., the single node repeater 102 or the DAS 202) is positioned away from the at least one base station and does not have any information about settings/configuration of the at least one base station. However, in order to serve the UEs 112 and to effectively switch between the uplink and downlink modes, the configuration/settings of the repeater system 102, 202 must be aligned with the configuration/settings of the at least one base station. Aligning the configuration of the repeater system 102, 202 with the configuration of the at least one base station may comprise aligning one or more signaling parameters of the repeater system 102, 202 with one or more signaling parameters of the at least one base station. In an exemplary aspect, the one or more signaling parameters of a base station have been shown in FIG. 3. It may be noted that the one or more signaling parameters are not limited to the parameters shown in FIG. 3 and, in general, the one or more signaling parameters may comprise additional parameters as well.

In current 5G NR network deployments, in order to configure a repeater system 102, 202 according to configuration of a base station, signaling parameters related to configuration of the base station are entered manually through a Graphical User Interface (e.g., using a web-based or command-line management interface implemented on the repeater system 102, 202). However, this approach of manually entering the signaling parameters is inefficient as it is time consuming, prone to human errors, and requires skilled/proficient operators for manually determining/calculating/deriving and entering the signaling parameters.

It may be worth noting that the configuration of the base station coupled with the repeater system 102, 202 may change with time. For instance, self-organizing network (SON) algorithms running in the communication system may change the base station configurations. In such scenarios, it is desirable for the repeater system 102, 202 to quickly reconfigure itself with the updated base station configuration in order to minimize any disruption in wireless services provided by the base station via the repeater system 102, 202. However, conventionally, whenever there is a change in the base station configuration, the operator has to manually update the signaling parameters, which puts a limitation of the operability and configurability of the repeater system 102, 202. For example, if there is a change in UL-DL transmission patterns of the base station, the operator has to manually update UL-DL transmission patterns of the repeater system 102, 202 based on the updated UL-DL transmission patterns of the base station. Hence, considerable efforts and resources are required to keep the repeater system configuration updated. Moreover, manually updating the DAS configuration consumes a significant amount of time and hence causes disruption in wireless services being provided by the base station via the repeater system 102, 202.

Thus, there exists a need for further improvements in the existing techniques of configuring the repeater systems for use with the 5G NR wireless air interface standard. Particularly, there exists a need for time and resource efficient techniques that can automatically configure the repeater system for use with the 5G NR wireless air interface standard while reducing overall costs and time required in configuring the repeater system.

The forthcoming paragraphs now describe various techniques for automatically acquiring the one or more signaling parameters related to the configuration/settings of the base station and automatically configuring a repeater system based on the configuration of the base station. It may be noted that in the forthcoming paragraphs, the techniques of acquiring the one or more signaling parameters and configuring the repeater system have been explained by considering the repeater system as the DAS 202 of FIG. 2. However, the present disclosure is not limited thereto and, in general, the techniques described below may be implemented in a single node repeater 102 (as shown in FIG. 1), a multi-node repeater, a DAS 202 (as shown in FIG. 2), a virtualized DAS, or any combinations thereof (e.g., where the single node repeater 102 is used to couple the DAS 202 to a remotely located base station using a wireless link).

Referring now to FIG. 3, which shows an exemplary list 300 comprising a plurality of signaling parameters related to configuration of the base station which need to be acquired in order to align the DAS configuration with the base station. The plurality of signaling parameters may comprise a first set of parameters (FS) and a second set of parameters (SS). In one non-limiting embodiment, the first set of parameters (FS) may comprise a System Frame Number (SFN), a Synchronization Signal Block (SSB) sub-carrier offset (K_SSB) or Ssb-SubCarrierOffset), a SSB subcarrier spacing (SCS), a bit error rate (BER), an error vector magnitude (EVM), ControlResourceSetZero, and SearchSpaceZero, but not limited thereto.

The System Frame Number (SFN) is a counter which requires 10 bits for representation, 6 bits of the SFN may be obtained from the Master Information Block (MIB) and the remaining 4 bits may be derived from the Physical Broadcast Channel (PBCH) payload. SFN may be used for synchronization of the DAS 202 (or UEs 112) with the base station. SSB SCS represents subcarrier spacing from 15 KHz to 240 KHz.

In 5G NR, search space or Physical Downlink Control Channel (PDCCH) search space refers to an area in the downlink resource grid where PDCCH may be carried. In order to decode the PDCCH, the UE is provided with information about a range which may carry the PDCCH. Within this range, UE performs blind decoding to decode the PDCCH. This range in which the UE performs the blind decoding is called search space. In 5G NR, there are two types of search spaces: UE specific search space and common search space. A common search space is shared across all UEs, while the UE-specific search space is specific for a UE. The common search space may be of different types (e.g., Type 0, Type 0A, Type 1, Type 2, Type 3). The parameter ‘controlResourceSetZero’ indicates a number of resource blocks used to determine a Control Resource Set (CORESET) size of the Type 0 common search space. The parameter ‘searchSpaceZero’ indicates PDCCH monitoring occasions (i.e., SFN and slot information) for the Type 0 common search space. The error vector magnitude (EVM) and bit error rate (BER) represent quality-of-service (QOS) parameters determined by analyzing the received downlink signals.

In one non-limiting embodiment, the second set of parameters (SS) may comprise one or more of: a SSB periodicity (ssbperiodicity), a carrier bandwidth (CarrierBw), PointA, OffsetToCarrier, OffsettoPointA, AbsoluteFrequency, dlulPeriodicity, a number of downlink slots (nrofDownlinkSlots), a number of downlink symbols (nrofDownlinkSymbols), a number of uplink slots (nrofUplinkSlots), a number of uplink symbols (nrofUplinkSymbols), but not limited thereto. The second set of parameters (SS) may be further divided into different subsets (e.g., a first subset of parameters (SS1), a second subset of parameters (SS2), a third subset of parameters (SS3), and a fourth subset of parameters (SS4)), as shown in FIG. 3. It may be noted that dividing the plurality of signaling parameters into different sets and subsets (as shown in FIG. 3) is for explanation purpose only and therefore, not to be taken in any limiting sense.

The forthcoming paragraphs now describe various techniques of acquiring the above-mentioned signaling parameters in order to align configuration of the DAS 202 with the configuration of the base station, in accordance with some embodiments of the present disclosure.

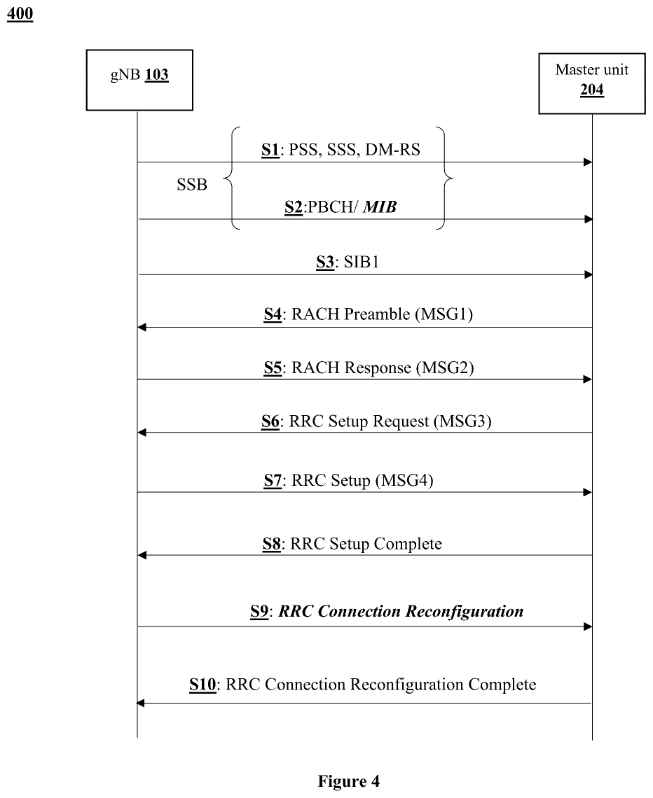

Referring now to FIG. 4, which shows a high level call flow diagram 400 illustrating message exchanges between a base station and the master unit 204 of a DAS 202 during 5G standalone (SA) initial attach process, in accordance with some embodiments of the present disclosure. Typically, when a user equipment (UE) is powered ON or when the UE enters a 5G NR cell, then before communicating with the gNB 103 serving the 5G NR cell, the UE 112 may perform cell search using 5G NR cell search procedures. According to 3GPP 5G NR specifications, cell search is the procedure by which the UE acquires time and frequency synchronization with the 5G NR cell and determines physical layer cell identity (Ng 11) of the 5G NR cell. In 5G NR, there are a total of 1008 unique physical layer cell identities. The physical layer cell identity may be determined by decoding a 5G NR Primary Synchronization Signal (PSS) and a 5G NR Secondary Synchronization Signal (SSS) located in a Synchronization Signal Block (SSB). For instance, the physical layer cell identity may be determined by following equation:

N_{ID}^{cell}=3N_{ID}⁽¹⁾+N_{ID}⁽²⁾ (1)

where
N_{ID}⁽¹⁾ indicates physical layer cell identity group which is derived from the SSS and has a value in the range {0, 1 . . . 335}; and
N_{ID}⁽²⁾ indicates physical layer cell identity which is derived from the SSS and has a value in the range {0, 1, 2}.

In 5G NR, the gNB 103 periodically broadcasts SSBs (step S1 of FIG. 4). Typically, the gNB 102 periodically transmits the SSBs in bursts (e.g., with a default periodicity of 20 ms). Each SSB burst may include up to N different SSBs (N=8 for FR1 frequency range and N=64 for FR2 frequency range) and each SSB may be associated with a unique time and/or frequency occasion or Random Access Channel (RACH) opportunity and each SSB of a SSB burst may be identified by a unique index called SSB index. Generally, a SSB carries synchronization signals (i.e., PSS and SSS) and initial system information which may be required by the UE 112 or the master unit 204 for initially attaching to a network. The SSB consists of PSS, SSS, Demodulation Reference Signals (DMRS), and Physical broadcast channel (PBCH)/Master Information Block (MIB). The DM-RS may serve as a reference for demodulating the MIB. The MIB is transmitted over the PBCH and carries mandatory system information broadcasted by the gNB 103 (step S2). The MIB comprises the necessary parameters required to decode System Information Block 1 (SIB1). In 5G NR, SIB1 is transmitted over Downlink Shared Channel (DL-SCH) and Physical Downlink Shared Channel (PDSCH) (step S3). The SIB1 comprises information required for the master unit 204 to access the 5G NR cell and information related to availability and scheduling of other SIBs. In one non-limiting exemplary embodiment, MIB and SIB1 may be referred to as Minimum System Information (MSI) and the SIB 1 alone may be referred to as Remaining Minimum System Information (RMSI). The gNB 103 may periodically or on-demand broadcast other system information (e.g., SIB2, SIB3, SIB9) via the DL-SCH and PDSCH channels (not shown in FIG. 4(a)).

In one non-limiting embodiment, since the master unit 204 is within the coverage range of the gNB 103, the master unit 204 may detect the SSB transmissions from the gNB 103. The master unit 204 may decode received system information i.e., the MIB (and optionally SIBs) to determine one or more of the first set of parameters (FS). For instance, the master unit 204 may decode the MIB to determine at least the System Frame Number (SFN), K_SSB, controlResourceSetZero, and searchSpaceZero. Further, remaining parameters of the first set of parameters (FS) i.e., SSB SCS, bit error rate (BER), error vector magnitude (EVM) may be derived based at least in part on decoding the MIB (e.g., based at least in part on analyzing the content of the MIB).

In this manner, the master unit 204 (or the DAS 202 more generally) may acquire the first set of parameters without connecting to a cell served by the gNB 103 and establishing two-way communication with the gNB 103 (i.e., the DAS 202 may acquire the first set of parameters in a listener only mode). However, the second set of parameters (SS) are a part of RRC Connection Reconfiguration. In 5G NR, the RRC Connection Reconfiguration message is sent from the gNB 103 to a UE 112 for setting up radio bearers and initiating UE measurements. In order to receive the RRC Connection Reconfiguration message by the master unit 204, the master unit 204 must connect to a cell served by the gNB 103 and establish two-way communication between the master unit 204 and the gNB 103. However, the master unit 204 generally acts as a simple bypass module (that is, a Layer-1 repeater) and does not have UE capabilities (e.g., in terms of performing signal processing) in order to transmit data originating at the master unit 204 for reception by the gNB 103 or to receive (that is, demodulate and decode) messages originating from the gNB 103 that are intended for the master unit 204. In other words, the master unit 204 does not have the capability to itself connect to a cell served by the gNB 103 and itself establish two-way communication with the gNB 103. Therefore, in order to connect to a cell served by the gNB 103 and establish two-way communication between the master unit 204 and the gNB 103, at least some of the functionalities of a UE are implemented in the master unit 204. In order to implement the UE functionalities, the processing circuitry 210 of the master unit 204 may configure the master unit 204 to act as a dummy UE and connect to a cell served by the gNB 103 and establish two-way communication with the gNB 103 just like a normal UE, as shown in FIG. 4.

Once the master unit 204 is configured as a dummy UE, it may perform Random access procedure. The master unit 204 may attempt random access by transmitting a RACH preamble (MSG1) on RACH resource corresponding to a selected SSB (step S4) and may start a timer T300 to await RRC connection setup message from the gNB 103. The gNB 103 may respond with a RACH response (MSG2) (step S5). The master unit 204 may then transmit a RRC connection setup request (MSG3) to the gNB 103 (step S6) and the gNB 103 may respond with a RRC connection setup message (MSG4) instructing the master unit 204 to set up the RRC connection (step S7). Upon receiving the RRC connection setup message, the master unit 204 may stop the timer T300. The gNB 103 may send RRC connection reconfiguration message on the PDSCH to the master unit 204 for setting up radio bearers and initiate UE measurements (step S9). The master unit 204 may reply to the gNB 103 with an RRC reconfiguration complete message (step S10).

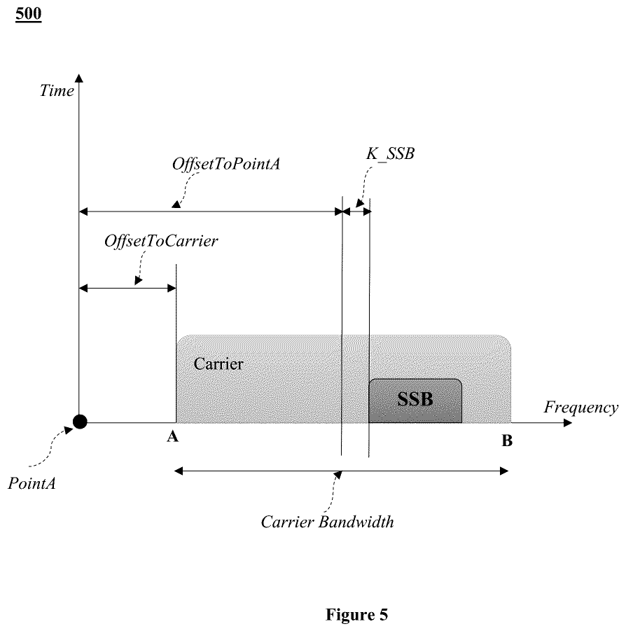

In this manner, the master unit 204 receives the RRC connection reconfiguration message from the gNB 103 on the PDSCH. The master unit 204 may decode the RRC connection reconfiguration message and derive the second set of parameters (SS). Specifically, at least some of the second set of parameters (e.g., a carrier bandwidth, OffsetToCarrier, dlulPeriodicity, a number of downlink slots, a number of downlink symbols, a number of uplink slots, a number of uplink symbols) may be directly derived by decoding the RRC connection reconfiguration message while remaining parameters of the second set of parameters (SS) may be determined by performing simple calculations on the first set of parameters and the at least some of the second set of parameters. For instance, the master unit 204 may determine PointA, OffsettoPointA, and AbsoluteFrequency from the first set of parameters (e.g., K_SSB) and the at least some of the second set of parameters (e.g., carrier bandwidth, OffsetToCarrier) using the relation among the different parameters (as shown in FIG. 5). The master unit 204 may further derive one or more additional parameters using the first and/or second sets of parameters.

In the above-described approach of acquiring the signaling parameters (particularly, the second set of parameters), the master unit 204 is configured to act as a dummy UE and connect to a cell served by the gNB 103 and establish two-way communication between the master unit 204 and the gNB 103. In another non-limiting embodiment, the present disclosure describes techniques of acquiring the signaling parameters without connecting to a cell served by the gNB 103 and establishing two-way communication between the gNB 103 and the master unit 204 (i.e., the master unit 204 acquires the signaling parameters corresponding to a cell served by the gNB 103 while operating in a “listener only” mode). In such embodiment, the first set of parameters (FS) may be acquired by the master unit 204 while operating in listener only mode e.g., using the procedure described in connection with FIG. 4 by decoding the system information (i.e., MIB) received from the gNB 103 in case of standalone mode of deployment. The master unit 204 may also determine the physical layer cell identity of the cell served by the gNB 103 using the equation (1).

Now, the second set of parameters (SS) may be determined by the master unit 204 by performing various signal processing, waveform correlation, and/or calculations while continuously operating in listener only mode. The master unit 204 may generate at least one ideal reference signal using the determined physical layer cell identity and determine a first subset of parameters (SS1) of the second set of parameters (SS) by correlating the generated at least one ideal reference signal with one or more known reference signals. The first subset of parameters (SS1) may comprise the carrier bandwidth. In one non-limiting embodiment, correlating a generated ideal reference signal with a known reference signal may comprise correlating a waveform of the generated ideal reference signal with a waveform of the known reference signal. The one or more known reference signals may be transmitted by the gNB 103 in downlink and may comprise Demodulation Reference Signal (DMRS), Phase Tracking Reference Signal (PTRS), Channel State Information Reference Signal (CSI-RS), and Tracking Reference Signal (TRS). The master unit 204 may correlate the at least one ideal reference signal generated using the determined physical layer cell identity with any of these known downlink reference signals to determine the first subset of parameters (SS1) i.e., the carrier bandwidth. For instance, if the at least one ideal reference signal generated using the determined physical layer cell identity is matching with a particular reference signal, the master unit 204 may determine that the particular reference signal is transmitted by the gNB 103. Now, by checking the bandwidth occupied by the particular reference signal, the master unit 204 may determine the carrier bandwidth. Typically, a reference signal transmission from the gNB 103 occupies the entire bandwidth and by sensing power on the entire bandwidth, the master unit 204 may estimate the carrier bandwidth.

Once the carrier bandwidth is determined, the master unit 204 may derive a second subset of parameters (SS2) (i.e., PointA, OffsetToCarrier, OffsettoPointA, and AbsoluteFrequency) of the second set of parameters by performing simple calculations using the carrier bandwidth. Particularly, the master unit 204 may derive the second subset of parameters (SS2) based at least in part on the first subset of parameters (SS1) and some or all of the first set of parameters (FS).

Referring now to FIG. 5, which shows an exemplary resource grid 500 showing SSB positioning, in accordance with some embodiments of the present disclosure. As shown in FIG. 5, at 5G NR, PointA may serve as a common reference point for resource block grids. OffsetToPointA may represent a frequency offset between point A and a lowest subcarrier of a lowest physical resource block (PRB) of the SSB used by the master unit 204 for cell selection. AbsoluteFrequencyPointA represents frequency location of point A and a center frequency of a SSB Block may be referred to as absoluteFrequencySSB. AbsoluteFrequency may be defined as the center frequency of the carrier. Based on the carrier bandwidth, the master unit 204 determines the starting frequency (A) and ending frequency (B) of the carrier by doing power scan(s). Using the starting and ending frequencies, the master unit 204 may calculate the center frequency of the carrier (i.e., the Absolute frequency).

In 5G NR, for a given frequency channel and a given bandwidth, the value of carrier offset (OffsetToCarrier) is fixed. So, the master unit 204 may determine the carrier offset based at least on the determined carrier bandwidth. The master unit 204 may then determine PointA based on the carrier offset and the value of the starting frequency (A) (see FIG. 5). Further, the master unit 204 may determine the value of OffsetToPointA based on the K_SSB (value of K_SSB is chosen from the first set of parameters) and the determined PointA, as shown in FIG. 5. In this manner, the second subset of parameters (SS2) may be determined.

The master unit 204 may determine a third subset of parameters (SS3) of the second set of parameters based at least on the first and second subsets of parameters (SS1, SS2) and uplink/downlink signals received by the DAS 202 on the carrier bandwidth part. For instance, the master unit 204 may monitor the carrier bandwidth part and process uplink/downlink signals received on the bandwidth part to determine DL-UL periodicity. Further, the master unit 204 may process the received uplink/downlink signals to determine a number of downlink slots, a number of downlink symbols, a number of uplink slots, and a number of uplink symbols. In one non-limiting embodiment, the master unit 204 may monitor energy levels of uplink and downlink signals to determine which frame belongs to uplink and which frame belongs to downlink. In this manner, the third subset of parameters may be determined. The third subset of parameters (SS3) may also be referred to as “basic TDD parameters” and may comprise DL-UL periodicity, a number of downlink slots, a number of downlink symbols, a number of uplink slots, and a number of uplink symbols.

Once the first and second subsets of parameters are acquired, the DAS 202 is perfectly aligned with the gNB 103. The master unit 204 may monitor the carrier bandwidth to determine a fourth subset of parameters (SS4) of the second set of parameters (SS). The fourth subset of parameters (SS4) may comprise SSB periodicity. In 5G NR, an SSB is periodically transmitted with a periodicity of 5 ms, 10 ms, 20 ms, 40 ms, 80 ms or 160 ms. By monitoring SSB transmissions for a predefined time period, the gNB 103 may determine the SSB periodicity. For instance, if the gNB 103 finds that within a time duration of 160 ms, 8 SSB transmissions are detected at a particular time/frequency resource, then it may determine that the SSB periodicity is 20 ms.

Once the first and second sets of parameters are acquired, the master unit 204 may tune one or more parameters or settings of the DAS 202 based at least in part on the first and/or second sets of parameters. In one non-limiting embodiment of the present disclosure, the master unit 204 may align TDD timings or TDD patterns of the DAS 202 (specifically, the master unit 204, the radio units 206, and the expansion units 208) in accordance with TDD patterns of the gNB 103. To do so, the master unit 204 may first determine the TDD timings (or TDD patterns) associated with the gNB 103 for serving the UEs 112 based on one or more of the first and second sets of parameters. Specifically, the master unit 204 may determine the TDD patterns associated with the gNB 103 based on the third subset of parameters. The TDD pattern associated with the gNB 103 may indicate timings when the gNB 103 switches from transmitting in the downlink direction to receiving in the uplink direction and the timings when the gNB 103 switches from receiving in the uplink direction to transmitting in the downlink direction. This TDD pattern may then be used by the master unit 204 in determining when the DAS 202 (i.e., the master unit 204, the radio units 206, and the expansion units 208) itself should switch between being operated in the downlink mode and being operated in the uplink mode. In other words, the master unit 204 may synchronize the DAS 202 with the gNB 103 by aligning TDD patterns of the DAS 202 (specifically, the master unit 204, the radio units 206, and the expansion units 208) in accordance with the determined TDD patterns of the gNB 103.

In one non-limiting embodiment, before aligning the TDD patterns of the DAS 202 in accordance with the determined TDD patterns of the gNB 103, the master unit 204 may apply an offset to the determined TDD patterns of the gNB 103 in order to account for propagation delays. In general, the master unit 204 may be configured to switch between the downlink mode and the uplink mode by switching the states of RF switches used in the master unit 204, the radio units 206, and the expansion units 208.

In one non-limiting embodiment, the master unit 204 may synchronize the DAS 202 with the gNB 103 by aligning one or more additional configurations/settings of the DAS 202 (e.g., a frequency band of operation, a downlink channel bandwidth, an uplink channel bandwidth, a downlink center frequency, an uplink center frequency, SSB periodicity etc.) based at least in part on the determined one or more signaling parameters of the gNB 103.

In one non-limiting embodiment, the master unit 204 may initiate the process of configuring the DAS 202 at the time of deployment of the DAS 202, upon occurrence of certain events or when one or more conditions are fulfilled (e.g., when one or more parameters do not satisfy preset criteria), upon detecting error conditions or upon detecting that the existing DAS configuration is outdated/inaccurate, and/or periodically. In one embodiment, an operator may manually initiate the process of configuring/re-configuring the DAS 202.

It may be noted that the above-described techniques of configuring the repeater system have been explained by way of standalone (SA) 5G NR deployment, where gNB 103 is used for both control-plane and user-plane communications. However, a skilled person would understand that the present disclosure is not limited thereto and, in general, the techniques of the present disclosure are equally applicable for configuring a repeater system in any type of deployment including non-standalone (NSA) 5G NR deployments or dual-connectivity deployment. In the NSA 5G NR deployment, the gNB 103 is used for user-plane communications with the UEs and the eNB 104 is used for control plane communications with the UEs. In NSA 5G NR deployment, the DAS 202 exchanges data with the gNB 103 while simultaneously exchanging data with the eNB 104. In such deployment, the UE may initially attach itself with 4G network (e.g., using eNB 104) and may report signal strength measurements of 5G frequencies to the eNB 104. Depending on the reported signal strength measurements, the eNB 104 may assign 5G resources to the UE and eventually the UE may simultaneously connect to 4G and 5G networks. In such deployment, the master unit 204 may acquire common signaling parameters (i.e., the parameters which are common for both 4G LTE and 5G NR) directly from the eNB 104 and may acquire remaining parameters either by operating as a dummy UE or by performing signal processing/calculations, as discussed in connection with FIGS. 4-5.

In one non-limiting embodiment, typically a downlink signal received from the at least one base station and an amplified version of an uplink signal communicated to the at least one base station may be received and communicated as analog radio frequency (RF) signals. However, the present disclosure is not limited thereto and in some non-limiting embodiments, the downlink signal received from the at least one base station and the amplified version of the uplink signal communicated to the at least one base station may be received and communicated in digital form as well. Also, the amplified version of the downlink signal wirelessly transmitted to the UEs 112, and the uplink signal wirelessly received from the UEs 112 are wirelessly transmitted and received as analog RF signals. In one non-limiting embodiment, the downlink signal may include one or more RF channels used for communicating in the downlink direction with the UEs 112 and the uplink signal may include one or more RF channels used for communicating in the uplink direction with the at least one base station.

The present disclosure provides various technical advantages. For instance, the techniques of the present disclosure enable a repeater system to quickly reconfigure itself with base station configuration in order to minimize any disruption in wireless services provided by the base station via the repeater system, thereby improving the user experience of already admitted UEs. Also, since the repeater system can automatically update its configurations according to the base station configurations, there is no need of manually updating the repeater system configurations, thereby reducing the overall time and resources consumption which would otherwise be required for manually configuring the repeater system.

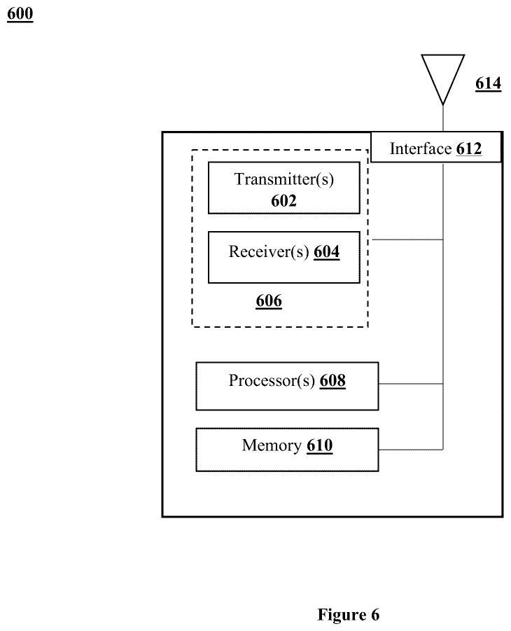

Referring now to, FIG. 6 which shows a high-level block diagram of an apparatus 600, in accordance with some embodiments of the present disclosure. The apparatus 600 may comprise at least one transmitter 602, at least one receiver 604, at least one processor 608, at least one memory 610, at least one interface 612, and at least one antenna 614. In one embodiment, the at least one transmitter 602 may be configured to wirelessly transmit data/information to one or more nodes/devices/units using the antenna 614 and the at least one receiver 604 may be configured to wirelessly receive data/information from the one or more nodes/devices using the antenna 614. The at least one transmitter and receiver may be collectively implemented as a single transceiver module 606. In one non-limiting embodiment, the at least one processor 608 may be communicatively coupled with the transceiver 606, memory 610, interface 612, and antenna 614.

The at least one processor 608 may include, but not restricted to, microprocessors, microcomputers, micro-controllers, central processing units, state machines, logic circuitries, and/or any devices that manipulate signals based on operational instructions. A processor may also be implemented as a combination of computing devices, e.g., a combination of a plurality of microprocessors or any other such configuration. The at least one memory 610 may be communicatively coupled to the at least one processor 608 and may comprise various instructions, information related to configuration of the repeater system and/or the at least one base station etc. The at least one memory 610 may include a Random-Access Memory (RAM) unit and/or a non-volatile memory unit such as a Read Only Memory (ROM), optical disc drive, magnetic disc drive, flash memory, Electrically Erasable Read Only Memory (EEPROM), a memory space on a server or cloud and so forth. The at least one processor 608 may be configured to execute one or more instructions stored in the memory 610.

The interfaces 612 may include a variety of software and hardware interfaces, for example, a web interface, a graphical user interface, an input device-output device (I/O) interface, a network interface, and the like. The I/O interfaces may allow the apparatus 600 to communicate with one or more nodes/units/devices either directly or through other devices. The network interface may allow the apparatus 600 to interact with one or more networks either directly or via any other network.

In one non-limiting embodiment, the apparatus 600 may be any of: the repeater system 102, 202; a part of the repeater system 102, 202 (e.g., the master unit 204, the remote unit 206, the expansion unit 208, or any other equivalent entity), a user equipment 112, a base station, but not limited thereto. In one non-limiting embodiment, the techniques of configuring the repeater system as described in conjunction with FIGS. 2-5 may be implemented with the help of the apparatus 600, where the processor 608 in conjunction with the transceiver 606, memory 610, interface 612, and antenna 614 may be configured to implement the techniques of configuring the repeater system.

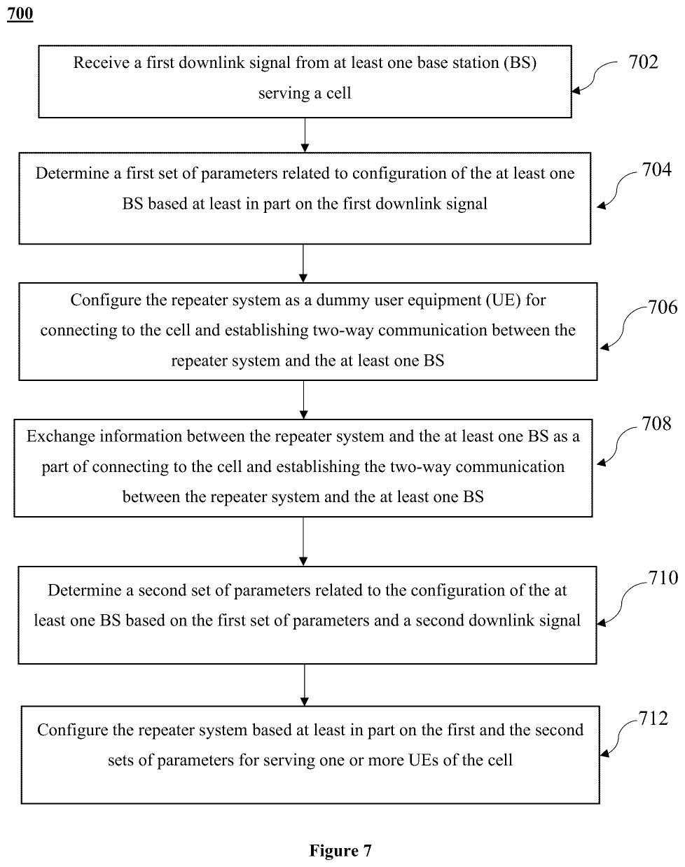

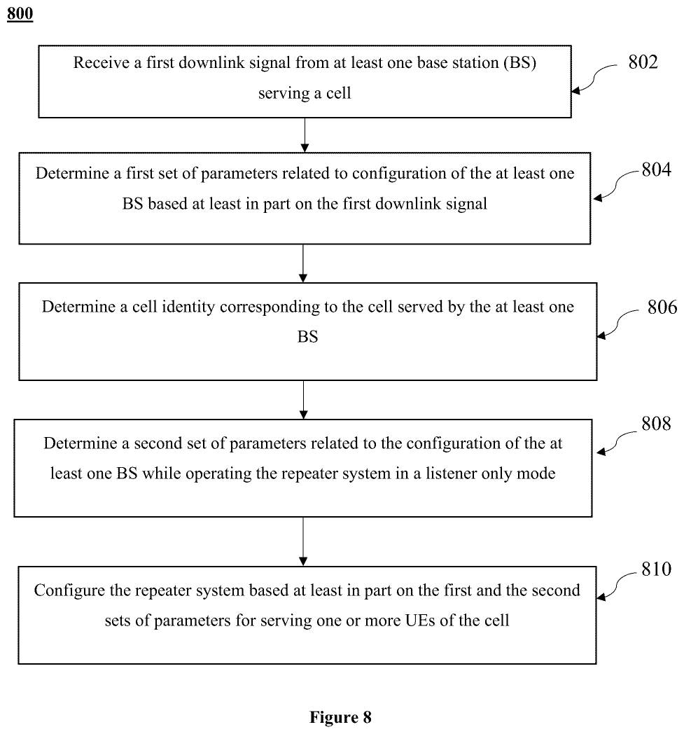

Referring now to FIGS. 7-8 which illustrate exemplary methods of configuring a repeater system 102, 202, according to various embodiments of the present disclosure. The methods described in FIGS. 7-8 may be performed by the single node repeater 102 or by the master node 204 of the DAS 202. In particular, the methods described in FIGS. 7-8 may be performed by the processing circuitry 110 of the single node repeater 102 or by the processing circuitry 210 of the master node 204.

Referring now to FIG. 7, a flowchart is described illustrating an exemplary method 700 of configuring a repeater system 102, 202, according to an embodiment of the present disclosure. The method 700 is merely provided for exemplary purposes, and embodiments are intended to include or otherwise cover any methods or procedures of configuring the repeater system.

The method 700 may include, at block 702, receiving a first downlink signal from at least one base station (BS) serving a cell. For example, the processing circuitry 110, 210 may be configured to receive the first downlink signal from the at least one base station serving the cell. In one non-limiting embodiment, the first downlink signal may comprise Master Information Block (MIB).

At block 704, the method 700 may include determining a first set of parameters related to configuration of the at least one BS based at least in part on the first downlink signal. For example, the processing circuitry 110, 210 may be configured to determine the first set of parameters related to the configuration of the at least one BS based at least in part on the first downlink signal (e.g., by decoding the first downlink signal).

At block 706, the method 700 may include configuring the repeater system 102, 202 as a dummy user equipment (UE) for connecting to the cell served by the at least one BS and establishing two-way communication between the repeater system and the at least one BS. For example, the processing circuitry 110, 210 may be configured to configure the repeater system 102, 202 as the dummy user equipment (UE) for connecting to the cell served by the at least one BS and establishing the two-way communication between the repeater system 102, 202 and the at least one BS. In one non-limiting embodiment, the operations of configuring the repeater system 102, 202 as the dummy UE may be performed before receiving the first downlink signal from the at least one base station (BS).

At block 708, the method 700 may include exchanging information between the repeater system 102, 202 and the at least one BS as a part of connecting to the cell served by the at least one BS and establishing the two-way communication between the repeater system 102, 202 and the at least one BS. For example, the processing circuitry 110, 210 may be configured to exchange information between the repeater system 102, 202 and the at least one BS as a part of connecting to the cell served by the at least one BS and establishing the two-way communication between the repeater system 102, 202 and the at least one BS.

In one non-limiting embodiment, exchanging the information between the repeater system 102, 202 and the at least one BS may comprise receiving a second downlink signal from the at least one BS. In one non-limiting embodiment, the second downlink signal may comprise Radio Resource Control (RRC) Connection Reconfiguration message.

At block 710, the method 700 may include determining a second set of parameters related to the configuration of the at least one BS based on the first set of parameters and the second downlink signal. For example, the processing circuitry 110, 210 may be configured to determine the second set of parameters related to the configuration of the at least one BS based on the first set of parameters and the second downlink signal.

At block 712, the method 700 may include configuring the repeater system 102, 202 based at least in part on the first and the second sets of parameters for serving one or more UEs 112 of the cell. For example, the processing circuitry 110, 210 may be configured to configure the repeater system 102, 202 based at least in part on the first and the second sets of parameters for serving one or more UEs 112 of the cell.

In one non-limiting embodiment of the present disclosure, the operation of block 712 i.e., configuring the repeater system 102, 202 based at least in part on the first and second sets of parameters may comprises determining Time-division duplexing (TDD) patterns associated with the at least one BS for serving the one or more UEs 112 of the cell based on one or more of the first and second sets of parameters, and aligning TDD patterns of the repeater system in accordance with the determined TDD patterns of the at least one BS.

In one non-limiting embodiment of the present disclosure, the repeater system 102, 202 may be a distributed antenna system (DAS) 202 comprising a master unit 204 and a plurality of remote units 206 communicatively coupled with the master unit 204 either directly or via one or more expansion units 208. In another non-limiting embodiment of the present disclosure, the DAS may comprise a virtualized DAS. In yet another non-limiting embodiment of the present disclosure, the repeater system 102, 202 may be a single node repeater 102 or a multi-node repeater.

In one non-limiting embodiment of the present disclosure, the at least one BS may comprise a 5G NR base station (i.e., gNB 103). In another non-limiting embodiment of the present disclosure, the at least one BS may comprise a 4G LTE base station (i.e., eNB 104).

Referring now to FIG. 8, a flowchart is described illustrating an exemplary method 800 of configuring a repeater system 102, 202, according to an embodiment of the present disclosure. The method 800 is merely provided for exemplary purposes, and embodiments are intended to include or otherwise cover any methods or procedures of configuring the repeater system.

The method 800 may include, at block 802, receiving a first downlink signal from at least one base station (BS) serving a cell. For example, the processing circuitry 110, 210 may be configured to receive the first downlink signal from the at least one base station serving the cell. In one non-limiting embodiment, the first downlink signal may comprise a Master Information Block (MIB).

At block 804, the method 800 may include determining a first set of parameters related to configuration of the at least one BS based at least in part on the first downlink signal. For example, the processing circuitry 110, 210 may be configured to determine the first set of parameters related to the configuration of the at least one BS based at least in part on the first downlink signal (e.g., by decoding the first downlink signal).

At block 806, the method 800 may include determining a cell identity corresponding to the cell served by the at least one BS. For example, the processing circuitry 110, 210 may be configured to determine the cell identity corresponding to the cell served by the at least one BS.

In one non-limiting embodiment of the present disclosure, the operation of block 806 i.e., determining the physical cell identity corresponding to the cell served by the at least one BS may comprises determining the physical cell identity by decoding a Primary Synchronization Signal (PSS) and a Secondary Synchronization Signal (SSS) received from the at least one BS.

At block 808, the method 800 may determine a second set of parameters related to the configuration of the at least one BS while operating the repeater system in a listener only mode. For example, the processing circuitry 110, 210 may be configured to determine the second set of parameters related to the configuration of the at least one BS while operating the repeater system in the listener only mode.

In one non-limiting embodiment of the present disclosure, the operation of block 808 i.e., determining the second set of parameters may comprise determining a first subset of parameters of the second set of parameters by correlating at least one reference signal generated using the determined cell identity with one or more reference signals transmitted by the at least one BS. The first subset of parameters may comprise a carrier bandwidth. In one non-limiting embodiment, the one or more reference signals may comprise a Demodulation Reference Signal (DMRS), a Phase Tracking Reference Signal (PTRS), a Channel State Information Reference Signal (CSI-RS), and a Tracking Reference Signal (TRS).

In one non-limiting embodiment of the present disclosure, the operation of block 808 i.e., determining the second set of parameters may further comprise determining a second subset of parameters of the second set of parameters based at least on the first subset of parameters and the first set of parameters. The second subset of parameters may comprise PointA, OffsetToCarrier, OffsettoPointA, and AbsoluteFrequency.

In one non-limiting embodiment of the present disclosure, the operation of block 808 i.e., determining the second set of parameters may further comprise determining a third subset of parameters of the second set of parameters based at least on the first and second subsets of parameters and uplink and downlink signals received by the repeater system. The third subset of parameters may comprise DL-UL Periodicity, a number of downlink slots, a number of downlink symbols, a number of uplink slots, a number of uplink symbols.

In one non-limiting embodiment of the present disclosure, the operation of block 808 i.e., determining the second set of parameters may further comprise determining a fourth subset of parameters of the second set of parameters by monitoring transmissions of Synchronization Signal Blocks (SSB s) within a predefined time window. The fourth subset of parameters may comprise a SSB periodicity.

At block 810, the method 800 may include configuring the repeater system 102, 202 based at least in part on the first and the second sets of parameters for serving one or more UEs 112 of the cell. For example, the processing circuitry 110, 210 may be configured to configure the repeater system 102, 202 based at least in part on the first and the second sets of parameters for serving one or more UEs 112 of the cell.

In one non-limiting embodiment of the present disclosure, the operation of block 810 i.e., configuring the repeater system 102, 202 based at least in part on the first and second sets of parameters may comprises determining Time-division duplexing (TDD) patterns associated with the at least one BS for serving the one or more UEs 112 of the cell based on one or more of the first and second sets of parameters, and aligning TDD patterns of the repeater system in accordance with the determined TDD patterns of the at least one BS.

In one non-limiting embodiment of the present disclosure, the repeater system 102, 202 may be a distributed antenna system (DAS) 202 comprising a master unit 204 and a plurality of remote units 206 communicatively coupled with the master unit 204 either directly or via one or more expansion units 208. In another non-limiting embodiment of the present disclosure, the DAS 202 may comprise a virtualized DAS. In yet another non-limiting embodiment of the present disclosure, the repeater system 102, 202 may be a single node repeater 102 or a multi-node repeater.

In one non-limiting embodiment of the present disclosure, the at least one BS may comprise a 5G NR base station (i.e., gNB 103). In another non-limiting embodiment of the present disclosure, the at least one BS may comprise a 4G LTE base station (i.e., eNB 104).

The above methods 700 and 800 may be described in the general context of computer executable instructions. Generally, computer executable instructions can include routines, programs, objects, components, data structures, procedures, modules, and functions, which perform specific functions or implement specific abstract data types.

The various blocks of the methods 700 and 800 shown in FIGS. 7-8 have been arranged in a generally sequential manner for ease of explanation. However, it is to be understood that this arrangement is merely exemplary, and it should be recognized that the processing associated with methods 700 and 800 (and the blocks shown in FIGS. 7-8) may occur in a different order (for example, where at least some of the processing associated with the blocks is performed in parallel and/or in an event-driven manner). Additionally, individual blocks may be deleted from the methods without departing from the spirit and scope of the subject matter described herein. Furthermore, the methods can be implemented in any suitable hardware, software, firmware, or combination thereof.

The various operations of methods described above may be performed by any suitable means capable of performing the corresponding functions. The means may include various hardware and/or software component(s) and/or module(s). Generally, where there are operations illustrated in Figures, those operations may have corresponding counterpart means-plus-function components.

It may be noted here that the subject matter of some or all embodiments described with reference to FIGS. 1-6 may be relevant for the methods and the same is not repeated for the sake of brevity.

In a non-limiting embodiment of the present disclosure, one or more non-transitory computer-readable media may be utilized for implementing the embodiments consistent with the present disclosure. A computer-readable media refers to any type of physical memory (such as the memory 610) on which information or data readable by a processor may be stored. Thus, a computer-readable media may store one or more instructions for execution by the at least one processor, including instructions for causing the at least one processor to perform steps or stages consistent with the embodiments described herein. Certain non-limiting embodiments may comprise a computer program product for performing the operations presented herein. For example, such a computer program product may comprise a computer readable media having instructions stored (and/or encoded) thereon, the instructions being executable by one or more processors to perform the operations described herein. For certain non-limiting embodiments, the computer program product may include packaging material.

The terms “connected”, “coupled”, and “communicatively coupled” and related terms may refer to direct or indirect connections. The phrase “based on” does not mean “based only on,” unless expressly specified otherwise. In other words, the phrase “based on” describes both “based only on” and “based at least on”. Additionally, the term “and/or” means “and” or “or”. For example, “A and/or B” can mean “A”, “B”, or “A and B”. Additionally, “A, B, and/or C” can mean “A alone,” “B alone,” “C alone,” “A and B,” “A and C,” “B and C” or “A, B, and C.”

As used herein, a phrase referring to “at least one” or “one or more” of a list of items refers to any combination of those items, including single members. As an example, “at least one of: A, B, or C” is intended to cover: A, B, C, A-B, A-C, B-C, and A-B-C. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the disclosed methods and systems.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the embodiments of the present disclosure are intended to be illustrative, but not limiting, of the scope of the disclosure, which is set forth in the appended claims.

### Example Embodiments

Example 1 includes a method of configuring a repeater system, the method comprising: receiving a first downlink signal from at least one base station (BS) serving a cell; determining a first set of parameters related to configuration of the at least one BS based at least in part on the first downlink signal; configuring the repeater system as a dummy user equipment (UE) for connecting to the cell and establishing two-way communication between the repeater system and the at least one BS; exchanging information between the repeater system and the at least one BS as a part of connecting to the cell and establishing the two-way communication between the repeater system and the at least one BS, wherein exchanging the information between the repeater system and the at least one BS comprises receiving a second downlink signal from the at least one BS; determining a second set of parameters related to the configuration of the at least one BS based on the first set of parameters and the second downlink signal; and configuring the repeater system based at least in part on the first and the second sets of parameters for serving one or more UEs of the cell.

Example 2 includes the method of Example 1, wherein the first downlink signal comprises a Master Information Block (MIB).

Example 3 includes the method of any of Examples 1-2, wherein the second downlink signal comprises a Radio Resource Control (RRC) Connection Reconfiguration message.

Example 4 includes the method of any of Examples 1-3, wherein configuring the repeater system based at least in part on the first and second sets of parameters comprises: determining Time-division duplexing (TDD) patterns associated with the at least one BS for serving the one or more UEs of the cell based on one or more of the first and second sets of parameters; and aligning TDD patterns of the repeater system in accordance with the determined TDD patterns of the at least one BS.

Example 5 includes the method of any of Examples 1-4, wherein the repeater system comprises at least one of: a distributed antenna system (DAS) comprising a master unit and a plurality of remote units communicatively coupled with the master unit either directly or via one or more expansion units; a virtualized DAS; and a single or multi node repeater.

Example 6 includes the method of any of Examples 1-5, wherein the at least one BS comprises at least one of: a Fifth Generation (5G) New Radio (NR) base station (gNB) and a fourth generation (4G) Long Term Evolution (LTE) base station (eNB).

Example 7 includes a method of configuring a repeater system, the method comprising: receiving a first downlink signal from at least one base station (BS) serving a cell; determining a first set of parameters related to configuration of the at least one BS based at least in part on the first downlink signal; determining a cell identity corresponding to the cell served by the at least one BS; determining a second set of parameters related to the configuration of the at least one BS while operating the repeater system in a listener only mode, wherein determining the second set of parameters comprises: determining a first subset of parameters of the second set of parameters by correlating at least one reference signal generated using the determined cell identity with one or more reference signals transmitted by the at least one BS; determining a second subset of parameters of the second set of parameters based at least on the first subset of parameters and the first set of parameters; and determining a third subset of parameters of the second set of parameters based at least on the first and second subsets of parameters and uplink and downlink signals received by the repeater system; and configuring the repeater system based at least in part on the first and the second sets of parameters for serving one or more UEs of the cell.

Example 8 includes the method of Example 7, further comprising: determining a fourth subset of parameters of the second set of parameters by monitoring transmissions of Synchronization Signal Blocks (SSB s) within a predefined time window, wherein the fourth subset of parameters comprises SSB periodicity.

Example 9 includes the method of any of Examples 7-8, wherein the first downlink signal comprises a Master Information Block (MIB).

Example 10 includes the method of any of Examples 7-9, wherein determining the cell identity corresponding to the cell served by the at least one BS comprises determining the cell identity by decoding a Primary Synchronization Signal (PSS) and a Secondary Synchronization Signal (SSS) received from the at least one BS.

Example 11 includes the method of any of Examples 7-10, wherein the one or more reference signals comprise a Demodulation Reference Signal (DMRS), a Phase Tracking Reference Signal (PTRS), a Channel State Information Reference Signal (CSI-RS), and a Tracking Reference Signal (TRS).

Example 12 includes the method of any of Examples 7-11, wherein configuring the repeater system based at least in part on the first and second sets of parameters comprises: determining Time-division duplexing (TDD) patterns associated with the at least one BS for serving the one or more UEs of the cell based at least on the third subset of parameters; and aligning TDD patterns of the repeater system in accordance with the determined TDD patterns of the at least one BS.

Example 13 includes the method of any of Examples 7-12, wherein the repeater system comprises at least one of: a distributed antenna system (DAS) comprising a master unit and a plurality of remote units communicatively coupled with the master unit either directly or via one or more expansion units; a virtualized DAS; and a single or multi node repeater.

Example 14 includes the method of any of Examples 7-13, wherein the at least one BS comprises at least one of: a Fifth Generation (5G) New Radio (NR) base station (gNB); and a fourth generation (4G) Long Term Evolution (LTE) base station (eNB).

Example 15 includes a repeater system, comprising: processing circuitry configured to: receive a first downlink signal from at least one base station (BS) serving a cell; determine a first set of parameters related to configuration of the at least one BS based at least in part on the first downlink signal; configure the repeater system as a dummy user equipment (UE) for connecting to the cell and establishing two-way communication between the repeater system and the at least one BS; exchange information between the repeater system and the at least one BS as a part of connecting to the cell and establishing the two-way communication between the repeater system and the at least one BS, wherein exchanging the information between the repeater system and the at least one BS comprises receiving a second downlink signal from the at least one BS; determine a second set of parameters related to the configuration of the at least one BS based on the first set of parameters and the second downlink signal; and configure the repeater system based at least in part on the first and the second sets of parameters for serving one or more UEs of the cell.

Example 16 includes the repeater system of Example 15, wherein the first downlink signal comprises a Master Information Block (MIB).

Example 17 includes the repeater system of any of Examples 15-16, wherein the second downlink signal comprises a Radio Resource Control (RRC) Connection Reconfiguration message.

Example 18 includes the repeater system of any of Examples 15-17, wherein to configure the repeater system based at least in part on the first and second sets of parameters, the processing circuitry is configured to: determine Time-division duplexing (TDD) patterns associated with the at least one BS for serving the one or more UEs of the cell based on one or more of the first and second sets of parameters; and align TDD patterns of the repeater system in accordance with the determined TDD patterns of the at least one BS.

Example 19 includes the repeater system of any of Examples 15-18, wherein the repeater system comprises at least one of: a distributed antenna system (DAS) comprising a master unit and a plurality of remote units communicatively coupled with the master unit either directly or via one or more expansion units; a virtualized DAS; and a single or multi node repeater.

Example 20 includes the repeater system of any of Examples 15-19, wherein the at least one BS comprises a Fifth Generation (5G) New Radio (NR) base station (gNB) and a fourth generation (4G) Long Term Evolution (LTE) base station (eNB).

Example 21 includes a repeater system, comprising: a processing circuitry configured to: receive a first downlink signal from at least one base station (BS) serving a cell; determine a first set of parameters related to configuration of the at least one BS based at least in part on the first downlink signal; determine a cell identity corresponding to the cell served by the at least one BS; determine a second set of parameters related to the configuration of the at least one BS while operating the repeater system in a listener only mode, wherein to determine the second set of parameters, the processing circuitry is configured to: determine a first subset of parameters of the second set of parameters by correlating at least one reference signal generated using the determined cell identity with one or more reference signals transmitted by the at least one BS; determine a second subset of parameters of the second set of parameters based at least on the first subset of parameters and the first set of parameters; and determine a third subset of parameters of the second set of parameters based at least on the first and second subsets of parameters and uplink and downlink signals received by the repeater system; and configure the repeater system based at least in part on the first and the second sets of parameters for serving one or more UEs of the cell.

Example 22 includes the repeater system of Example 21, wherein the processing circuitry is further configured to: determine a fourth subset of parameters of the second set of parameters by monitoring transmissions of Synchronization Signal Blocks (SSBs) within a predefined time window, wherein the fourth subset of parameters comprises SSB periodicity.

Example 23 includes the repeater system of any of Examples 21-22, wherein the first downlink signal comprises a Master Information Block (MIB).

Example 24 includes the repeater system of any of Examples 21-23, wherein to determine the cell identity corresponding to the cell served by the at least one BS, the processing circuitry is configured to determine the cell identity by decoding a Primary Synchronization Signal (PSS) and a Secondary Synchronization Signal (SSS) received from the at least one BS.

Example 25 includes the repeater system of any of Examples 21-24, wherein the one or more reference signals comprise a Demodulation Reference Signal (DMRS), a Phase Tracking Reference Signal (PTRS), a Channel State Information Reference Signal (CSI-RS), and a Tracking Reference Signal (TRS).

Example 26 includes the repeater system of any of Examples 21-25, wherein to configure the repeater system based at least in part on the first and second sets of parameters, the repeater system is configured to: determine Time-division duplexing (TDD) patterns associated with the at least one BS for serving the one or more UEs of the cell based at least on the third subset of parameters; and align TDD patterns of the repeater system in accordance with the determined TDD patterns of the at least one BS.

Example 27 includes the repeater system of any of Examples 21-26, wherein the repeater system comprises at least one of: a distributed antenna system (DAS) comprising a master unit and a plurality of remote units communicatively coupled with the master unit either directly or via one or more expansion units; a virtualized DAS; and a single or multi node repeater.

Example 28 includes the repeater system of any of Examples 21-27, wherein the at least one BS comprises a Fifth Generation (5G) New Radio (NR) base station (gNB) and a fourth generation (4G) Long Term Evolution (LTE) base station (eNB).

What is claimed is:

1. A method of configuring a repeater system, the method comprising:
receiving a first downlink signal from at least one base station (BS) serving a cell;
determining a first set of parameters related to configuration of the at least one BS based at least in part on the first downlink signal;
configuring the repeater system as a dummy user equipment (UE) for connecting to the cell and establishing two-way communication between the repeater system and the at least one BS;
exchanging information between the repeater system and the at least one BS as a part of connecting to the cell and establishing the two-way communication between the repeater system and the at least one BS, wherein exchanging the information between the repeater system and the at least one BS comprises receiving a second downlink signal from the at least one BS;
determining a second set of parameters related to the configuration of the at least one BS based on the first set of parameters and the second downlink signal; and
configuring the repeater system based at least in part on the first and the second sets of parameters for serving one or more UEs of the cell.

2. The method of claim 1, wherein the first downlink signal comprises a Master Information Block (MIB).

3. The method of claim 1, wherein the second downlink signal comprises a Radio Resource Control (RRC) Connection Reconfiguration message.

4. The method of claim 1, wherein configuring the repeater system based at least in part on the first and second sets of parameters comprises:
determining Time-division duplexing (TDD) patterns associated with the at least one BS for serving the one or more UEs of the cell based on one or more of the first and second sets of parameters; and
aligning TDD patterns of the repeater system in accordance with the determined TDD patterns of the at least one BS.

5. The method of claim 1, wherein the repeater system comprises at least one of:
a distributed antenna system (DAS) comprising a master unit and a plurality of remote units communicatively coupled with the master unit either directly or via one or more expansion units;
a virtualized DAS; and
a single or multi node repeater.

6. The method of claim 1, wherein the at least one BS comprises at least one of: a Fifth Generation (5G) New Radio (NR) base station (gNB) and a fourth generation (4G) Long Term Evolution (LTE) base station (eNB).

7. A method of configuring a repeater system, the method comprising:
receiving a first downlink signal from at least one base station (BS) serving a cell;
determining a first set of parameters related to configuration of the at least one BS based at least in part on the first downlink signal;
determining a cell identity corresponding to the cell served by the at least one BS;
determining a second set of parameters related to the configuration of the at least one BS while operating the repeater system in a listener only mode, wherein determining the second set of parameters comprises:
determining a first subset of parameters of the second set of parameters by correlating at least one reference signal generated using the determined cell identity with one or more reference signals transmitted by the at least one BS;
determining a second subset of parameters of the second set of parameters based at least on the first subset of parameters and the first set of parameters; and
determining a third subset of parameters of the second set of parameters based at least on the first and second subsets of parameters and uplink and downlink signals received by the repeater system; and
configuring the repeater system based at least in part on the first and the second sets of parameters for serving one or more UEs of the cell.

8. The method of claim 7, further comprising:
determining a fourth subset of parameters of the second set of parameters by monitoring transmissions of Synchronization Signal Blocks (SSBs) within a predefined time window, wherein the fourth subset of parameters comprises SSB periodicity.

9. The method of claim 7, wherein the first downlink signal comprises a Master Information Block (MIB).

10. The method of claim 7, wherein determining the cell identity corresponding to the cell served by the at least one BS comprises determining the cell identity by decoding a Primary Synchronization Signal (PSS) and a Secondary Synchronization Signal (SSS) received from the at least one BS.

11. The method of claim 7, wherein the one or more reference signals comprise a Demodulation Reference Signal (DMRS), a Phase Tracking Reference Signal (PTRS), a Channel State Information Reference Signal (CSI-RS), and a Tracking Reference Signal (TRS).

12. The method of claim 7, wherein configuring the repeater system based at least in part on the first and second sets of parameters comprises:
determining Time-division duplexing (TDD) patterns associated with the at least one BS for serving the one or more UEs of the cell based at least on the third subset of parameters; and
aligning TDD patterns of the repeater system in accordance with the determined TDD patterns of the at least one BS.

13. The method of claim 7, wherein the repeater system comprises at least one of:
a distributed antenna system (DAS) comprising a master unit and a plurality of remote units communicatively coupled with the master unit either directly or via one or more expansion units;
a virtualized DAS; and
a single or multi node repeater.

14. The method of claim 7, wherein the at least one BS comprises at least one of: a Fifth Generation (5G) New Radio (NR) base station (gNB); and a fourth generation (4G) Long Term Evolution (LTE) base station (eNB).

15. A repeater system, comprising:
processing circuitry configured to:
receive a first downlink signal from at least one base station (BS) serving a cell;
determine a first set of parameters related to configuration of the at least one BS based at least in part on the first downlink signal;
configure the repeater system as a dummy user equipment (UE) for connecting to the cell and establishing two-way communication between the repeater system and the at least one BS;
exchange information between the repeater system and the at least one BS as a part of connecting to the cell and establishing the two-way communication between the repeater system and the at least one BS, wherein exchanging the information between the repeater system and the at least one BS comprises receiving a second downlink signal from the at least one BS;
determine a second set of parameters related to the configuration of the at least one BS based on the first set of parameters and the second downlink signal; and
configure the repeater system based at least in part on the first and the second sets of parameters for serving one or more UEs of the cell.

16. The repeater system of claim 15, wherein the first downlink signal comprises a Master Information Block (MIB).

17. The repeater system of claim 15, wherein the second downlink signal comprises a Radio Resource Control (RRC) Connection Reconfiguration message.

18. The repeater system of claim 15, wherein to configure the repeater system based at least in part on the first and second sets of parameters, the processing circuitry is configured to:
determine Time-division duplexing (TDD) patterns associated with the at least one BS for serving the one or more UEs of the cell based on one or more of the first and second sets of parameters; and
align TDD patterns of the repeater system in accordance with the determined TDD patterns of the at least one BS.

19. The repeater system of claim 15, wherein the repeater system comprises at least one of:
a distributed antenna system (DAS) comprising a master unit and a plurality of remote units communicatively coupled with the master unit either directly or via one or more expansion units;
a virtualized DAS; and
a single or multi node repeater.

20. The repeater system of claim 15, wherein the at least one BS comprises a Fifth Generation (5G) New Radio (NR) base station (gNB) and a fourth generation (4G) Long Term Evolution (LTE) base station (eNB).

21. A repeater system, comprising:
a processing circuitry configured to:
receive a first downlink signal from at least one base station (BS) serving a cell;
determine a first set of parameters related to configuration of the at least one BS based at least in part on the first downlink signal;
determine a cell identity corresponding to the cell served by the at least one BS;
determine a second set of parameters related to the configuration of the at least one BS while operating the repeater system in a listener only mode, wherein to determine the second set of parameters, the processing circuitry is configured to:
determine a first subset of parameters of the second set of parameters by correlating at least one reference signal generated using the determined cell identity with one or more reference signals transmitted by the at least one BS;
determine a second subset of parameters of the second set of parameters based at least on the first subset of parameters and the first set of parameters; and
determine a third subset of parameters of the second set of parameters based at least on the first and second subsets of parameters and uplink and downlink signals received by the repeater system; and
configure the repeater system based at least in part on the first and the second sets of parameters for serving one or more UEs of the cell.

22. The repeater system of claim 21, wherein the processing circuitry is further configured to:
determine a fourth subset of parameters of the second set of parameters by monitoring transmissions of Synchronization Signal Blocks (SSBs) within a predefined time window, wherein the fourth subset of parameters comprises SSB periodicity.

23. The repeater system of claim 21, wherein the first downlink signal comprises a Master Information Block (MIB).

24. The repeater system of claim 21, wherein to determine the cell identity corresponding to the cell served by the at least one BS, the processing circuitry is configured to determine the cell identity by decoding a Primary Synchronization Signal (PSS) and a Secondary Synchronization Signal (SSS) received from the at least one BS.

25. The repeater system of claim 21, wherein the one or more reference signals comprise a Demodulation Reference Signal (DMRS), a Phase Tracking Reference Signal (PTRS), a Channel State Information Reference Signal (CSI-RS), and a Tracking Reference Signal (TRS).

26. The repeater system of claim 21, wherein to configure the repeater system based at least in part on the first and second sets of parameters, the repeater system is configured to:
determine Time-division duplexing (TDD) patterns associated with the at least one BS for serving the one or more UEs of the cell based at least on the third subset of parameters; and
align TDD patterns of the repeater system in accordance with the determined TDD patterns of the at least one BS.

27. The repeater system of claim 21, wherein the repeater system comprises at least one of:
a distributed antenna system (DAS) comprising a master unit and a plurality of remote units communicatively coupled with the master unit either directly or via one or more expansion units;
a virtualized DAS; and
a single or multi node repeater.

28. The repeater system of claim 21, wherein the at least one BS comprises a Fifth Generation (5G) New Radio (NR) base station (gNB) and a fourth generation (4G) Long Term Evolution (LTE) base station (eNB).
